(19) United States
(12) Patent Application Publication
(10) Pub. No.: US 2011/0287375 A1
(43) Pub. Date: Nov. 24, 2011

(54) WIRELESS TEMPERATURE SENSING AND CONTROL SYSTEM FOR METAL KILN AND METHOD OF USING THE SAME

(75) Inventors: John M. Peterman, Weldon Spring, MO (US); Mark A. Roberts, St. Charles, MO (US)

(73) Assignee: GILLESPIE + POWERS, INC., St. Louis, MO (US)

(21) Appl. No.: 13/111,633

(22) Filed: May 19, 2011

Related U.S. Application Data
(60) Provisional application No. 61/346,199, filed on May 19, 2010.

(51) Int. Cl. F27D 19/00

(52) U.S. Cl. 432/36

(57) ABSTRACT

A rotary aluminum kiln temperature regulation system comprising a temperature sensing device in the kiln that is configured to take temperature readings in an area of the kiln in proximity to the temperature sensing device. The system including a wireless transmitter operatively associated with the temperature sensing device and a receiver wirelessly associated with the transmitter, such that the transmitter and receiver wirelessly transmit the temperature readings taken by the temperature sensing device from the transmitter to the receiver. The system also including a control unit operatively connected to the receiver that is configured to receive the transmitted temperature readings and determine when the transmitted temperature readings exceed a predefined temperature setpoint. The control unit is operatively connected to a heat flow control device that can adjust heat flow inside the kiln in proximity to the temperature sensing device, such that the control unit regulates the heat flow control device to maintain a desired level of heat flow in the kiln in proximity to the temperature sensing device in response to the temperature readings transmitted from the temperature sensing device.

### CROSS REFERENCE TO RELATED APPLICATIONS

This application derives and claims priority from U.S. provisional application 61/346,199 filed 19 May 2010, which application is incorporated herein by reference.

### STATEMENT REGARDING FEDERALLY SPONSORED RESEARCH OR DEVELOPMENT

Not applicable.

### BACKGROUND OF THE INVENTION

This invention relates principally to a metal furnace or kiln, and more particularly to a temperature sensing and control system for rotary aluminum delacquering kilns using wireless thermocouples or comparable temperature sensing devices.

It has for some time been a standard practice to recycle scrap metals, and in particular scrap aluminum. Various furnace and kiln systems exist that are designed to recycle and recover aluminum from various sources of scrap, such as used beverage cans (“UBC”), siding, windows and door frames, etc. One of the first steps in these processes is to use a rotary kiln to remove the paints, oils, and other surface materials on the scrap aluminum (i.e. “feed material”). This is commonly known in the industry as “delacquering.” Delacquering is typically performed in an atmosphere with reduced oxygen levels and temperatures in excess of 900 degrees Fahrenheit. The temperature at which the paints and oils and other surface materials are released from the aluminum scrap in the form of unburned volatile gases is known as the “volatilization point.” One such typical aluminum recycling system utilizes a rotary kiln to delacquer the aluminum. Many of these systems utilize a recirculating heat apparatus comprising a burner with a blower to direct heat into the kiln, and a recovery device that collects exhaust heat from the kiln and recirculates the recovered heat into the heat flow for the kiln.

Due to the difficulties in accessing the rotating material during operation, the temperatures in traditional rotary aluminum kilns are not regularly monitored. Sensing devices external of the kiln are sometimes used as a temperature testing method. This requires manual intervention and is not particularly accurate. Unfortunately, failure to consistently and accurately monitor the conditions in the kiln can lead to fires. These fires result when the feed material reaches the volatilization point too rapidly and the feed material begins to rapidly oxidize and generate its own heat, leading to a high temperature excursion (i.e. “overtemp event”). Applicants have learned through tests, utilizing wireless high temperature thermocouples placed in the kiln, that certain temperature profiles occur in the feed material that can be used as precursors to predict such high temperature excursions or overtemp events, and that such events can arise in as little as 10 minutes of operation and can arise in different locations within the kiln. Further, applicants have learned through testing that controlling the heat flow into the kiln can regulate and prevent such overtemp events. These overtemp events can occur at different positions along the length of the feed material in the kiln, and may be affected by such variables as the size of the feed material put into the kiln, the moisture content of the feed material, the volume of the feed material and the feed rate, the composition of the feed material, and the cleanliness of feed material. A fire in a rotary aluminum kiln can require a costly shut-down, will likely destroy the feed material, and can damage the kiln and other associated equipment.

One example of a condition that can lead to an overtemp event concerns the presence of magnesium in aluminum feed material. Most aluminum cans (e.g. UBC's) have lids or tops that comprise a higher percentage of magnesium than the body of the can. Magnesium melts at a lower temperature than aluminum, and is very combustive. When placed in a rotary aluminum kiln, the aluminum can lids can separate from the aluminum can body. This is known in the industry as “lid fracturing”. This lid fracturing reduces the lids to particles of aluminum and magnesium as small as a grain of sand. Oxidation of these particles in the kiln occurs very rapidly, resulting in highly combustible partially oxidized aluminum and magnesium. The amount of heat in the kiln must be reduced or the partially oxidized aluminum and magnesium can accelerate in temperature and ignite in the kiln. Like other overtemp events, such UBC lids fracture events can be localized to one or more zones within the kiln. However, once ignition occurs the fire can flash rapidly throughout the kiln.

As will become evident in this disclosure, the present invention provides benefits over the existing art.

### BRIEF DESCRIPTION OF THE DRAWINGS

The illustrative embodiments of the present invention are shown in the following drawings which form a part of the specification:

FIG. 1 is a schematic of an aluminum rotary kiln delacquring system incorporating one embodiment of the present invention;

Corresponding reference characters indicate corresponding parts throughout the several views of the drawings.

### DETAILED DESCRIPTION

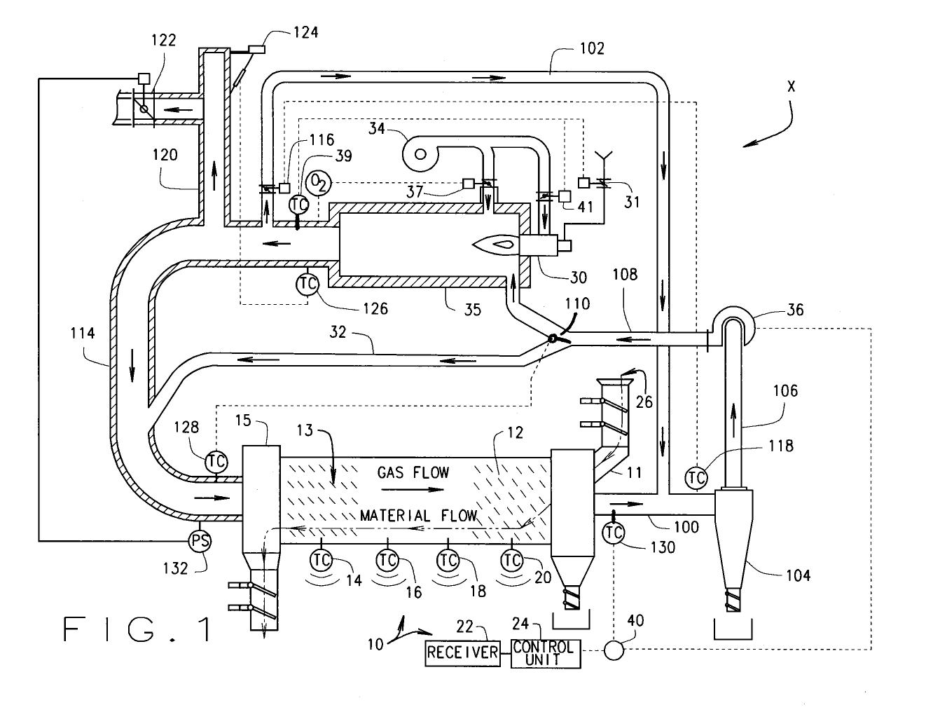

In referring to the drawings, a schematic embodiment of the novel wireless temperature sensing and control system for metal kiln 10 of the present invention is shown generally in FIG. 1, where the present invention is depicted by way of example as integrated into a representative mass flow delacquering system X with a rotary aluminum kiln 12 having a delacquering zone 13 within the kiln 12. As can be seen, a set of four independent high temperature thermocouples 14, 16, 18 and 20, are positioned along the length of the kiln 12. In practice, the thermocouples 14, 16, 18 and 20 are positioned with at least the temperature sensing portion of the thermocouple exposed to the delacquering zone 13 within the rotary kiln 12. All of the thermocouples 14, 16, 18 and 20 are configured to detect temperature readings in the kiln 12, including temperature readings in excess of the melting point of aluminum, and are further configured to transmit the temperature readings they sense inside of the kiln 12 via radio signals to a receiving device or receiver 22 that is external of the kiln 12. Alternately, the thermocouples 14, 16, 18 and 20 could be operatively connected to a wireless transmitter (not shown) that would transmit the temperature readings to the receiving device or receiver 22.

Aluminum feed material 26, which is ready for the delaquering process, is supplied to the kiln 12 through a feed material control chute 11, which regulates the rate at which the feed material is supplied to the kiln 12. The material then travels through the kiln 12 as the kiln 12 rotates about its central axis, and the material 26 is then discharged through a discharge chute 15, which regulates the rate at which feed material is discharged from the kiln 12. In order to reach and maintain temperatures sufficient to delacquer aluminum feed material 26 in the depicted system X, the kiln 12 receives heated air from a burner 30 and a burner bypass pipe 32. The burner 30 receives ambient temperature air, at a temperature of approximately 70 degrees F., from a combustion blower 34 and recirculated gases, at a temperature of approximately 500 degrees F., from a variable speed recirculation blower 36 which in turn receives the recirculated heated gases that have passed through the kiln 12. Combustion gases are controllably supplied to the burner 30 through a mass flow controller 31. The combustion blower 34 also drives the ambient temperature air into an afterburner 35 attached to the burner 30. Oxygen can be controllably injected as desired directly into the afterburner 35 through a mass flow controller 37. A thermocouple 39 positioned near the exit for the afterburner 35 takes temperature readings of the gases as they exit the afterburner. The thermocouple 39 connects to the combustion gas mass flow controller 31 and a mass flow controller 41, positioned between the combustion blower 34 and the burner 30, such that the mass flow controllers 31 and 41 regulate the flow of combustion gases and air, respectively, in response to the temperature readings from the thermocouple 39, so as to automatically control the burner operation to control the temperature of the gases supplied through a supply pipe 114.

Because the recirculation blower 36 simultaneously supplies preheated air to the burner 30 and the kiln 12, the volume of heated air supplied to the kiln 12 in system X can be predictably controlled by varying the speed of the blower 36. Because the volume of heated air supplied to the kiln 12 in turn affects the amount of heat injected into the kiln 12 and thereby to the feed material 26 in the delacquering zone 13 within the kiln 12, varying the speed of the blower 36 has a and controllable predictable impact on the amount of heat applied to the feed material 26 in the delacquering zone 13.

The receiver 22 is operatively connected to a programmable control unit 24, although in other configurations the control unit 24 can comprise the receiver 22. Of course, wires or wireless devices may alternatively be used to operatively connect components positioned outside the kiln 12 or outside the gas and material flow components of the system X. Hence, for example, the receiver 22 may be wired to or wirelessly connected to the control unit 24. The kiln temperatures transmitted from the thermocouples 14, 16, 18 and 20 to the receiver 22 are communicated to the control unit 24. In traditional configurations, an automated feedback loop adjusts the speed of the blower 36 in response to the quantity and rate of feed material directed into the kiln 12. In the present configuration of FIG. 1, the control unit 24 is operatively connected to and controls a mass flow controller 40 that regulates the speed of the recirculation blower 36, and thereby the heat applied to the feed material 26 in the delacquering zone 13 within the kiln 12. The control unit 24 may be wired to or wirelessly connected to the mass flow controller 40. The control unit 24 automatically controls the speed of the blower 36, using commands to the mass flow controller 40, based upon a predetermined process loop control algorithm programmed into the control unit 24.

As seen in FIG. 1, in a representative mass flow delacquering system X, gases exiting the kiln 12 travel through an exit pipe 100, where a bypass pipe 102 joins the exit pipe 100. The temperature of the gases traveling in this area of the system X is approximately 500 degrees F. The gases are then directed into a cyclone 104, through an inlet pipe 106 into the recirculating blower 36. The blower 36 both draws the gases from the cyclone 104 and pushes the gases into supply pipe 108. A diverter valve 110 is positioned at a junction along the pipe 108 to direct the gas flow into an afterburner 35 or through the burner bypass pipe 32. Gases directed into the afterburner 35 are subjected to the heat generated by the burner 30, where the gas temperature is raised to approximately 1500 degrees F. The gases are then directed out of the afterburner 35 and directed along the supply pipe 114 to the kiln 12.

Near the afterburner 35, the bypass pipe 102 is connected to the supply pipe 114, where a portion of the gases are diverted to the exit pipe 100. The amount of gas that is allowed to exit through the bypass pipe 102 is controlled by a bypass valve 116. The bypass valve 116 is, in turn, connected to a thermocouple 118 in the exit pipe 100, and the valve 116 opens and closes in response to the temperature readings supplied by the thermocouple 118.

Downstream from the junction of the bypass pipe 102 and the supply pipe 114, a vent pipe 120 joins the supply pipe 114. The vent line connects to a pressure control damper 122 and, through which the gas pressure in the system X can be controlled. In addition, an emergency vent stack 124, that is triggered by temperature readings supplied from a thermocouple 126 in the supply pipe 114 near the exit for the afterburner, connects to the vent pipe to provide for a safety pressure relief for the system X.

Before entering the kiln 12, the supply pipe 114 is joined by the burner bypass pipe 32. By utilizing the diverter valve 110 to controllably combining the higher temperature gases supplied by the afterburner with the lower temperature gases supplied by the bypass 32, the user can regulate the temperature of the gases supplied to the kiln 12. A nominal target temperature for a typical delaquering operation is approximately 1100 degrees F. The diverter valve 110 is connected to a thermocouple 128 in the supply pipe 114 near the entrance to the kiln 12, and the valve 110 rotates to control the ratio of gases directed into the afterburner 35 as opposed to the bypass 32, in response to the temperature readings supplied by the thermocouple 128.

A thermocouple 130 near the junction of the kiln 12 and the exit pipe 100 takes temperature readings of the gases as they exit the kiln 12. This temperature data provides an additional source of information to alternatively control the mass flow controller 40. The temperature readings from thermocouple 130 may be used separate from or in conjunction with the operation of the control unit 24.

A pressure sensor 132 is positioned in the supply pipe 114 near the entrance to the kiln 12. The pressure sensor 132 is connected to and controls the pressure control damper 122 in the vent stack 120.

Upon initial setup, the wireless thermocouples 14, 16, 18 and 20 can be used to profile the temperatures along the inner length of the kiln 12. This profile is then programmed into the control unit 24 as a baseline from which overtemp events are detected and to which a response is performed. During operation of the system X, the control unit 24 constantly and automatically monitors the kiln 12 via the temperatures received from each of the wireless thermocouples 14, 16, 18 and 20. The algorithm in the control unit 24 is programmed to use the baseline profile to monitor for spikes or unacceptable increases in temperature in the feed material 26 in the delacquering zone 13 within the kiln 12, and automatically control the heat supplied to the kiln 12 to prevent fires in the kiln 12 and otherwise maintain a proper operational delacquering profile within the kiln 12.

In a simple form, and by way of example, should any one or more of the thermocouples 14, 16, 18 and 20, detect a temperature that exceeds a predetermined high limit setpoint for a period of time that exceeds a predetermined duration, or should one or more of the thermocouples 14, 16, 18 and 20, detect an abnormal temperature pattern in the kiln 12 such as a rapid rise in temperature, the control unit 24 then automatically instructs the mass flow controller 40 to decrease the speed of the blower 36 a predetermined amount based upon the anticipated reduction in heat that is necessary to avoid a fire in the kiln 12, as formulated from tests and calculations. Should the temperatures in the kiln 12 drop below a lower limit setpoint for a period of time that exceeds a duration setpoint, the control unit 24 then automatically instructs the mass flow controller 40 to increase the speed of the blower 36 a predetermined amount based upon the anticipated increase in heat that is necessary to properly operate the kiln 12, also as formulated from tests and calculations. Of course, one skilled in the art will recognize that much more complex algorithms may be incorporated in the control unit 24 to enable refined control of the temperature profile of the feed material 13 and the and the efficiency of the kiln 12.

In an even more simplified variant of the novel wireless temperature sensing and control system for metal kiln 10 of the present invention (not shown), there is no control loop to automatically control the heat supplied to the kiln 12. Rather, when an overtemp event is identified by the control unit 24 from the wireless thermocouples 14, 16, 18 and 20, such as for example when any one or more of the thermocouples 14, 16, 18 and 20, detects a temperature that exceeds a predetermined high limit temperature setpoint for a period of time that exceeds a predetermined duration, or should one or more of the thermocouples 14, 16, 18 and 20, otherwise detect an abnormal temperature pattern in the kiln 12 such as a rapid rise in temperature, the control unit 24 generates a notification. The notification can activate a notification apparatus, such as triggering an alarm (not shown) to alert the system X operators of a potential fire threat in the kiln 12. The system X operators can then inspect the situation and make any manual or automated adjustments to the system X operation as they see fit.

Of course, the programmable control unit 24 may be operatively connected to and control in response to the temperature readings from any one or more of the thermocouples 14, 16, 18 and 20, any one or more of the heat flow control devices in the system X, which include for example and without limitation, the pressure control damper 122, the combustion blower 34, the combustion oxygen supply mass flow controller 37, the combustion gas mass flow controller 31, the combustion air mass flow controller 41, the diverter valve 110, the emergency vent 124, the bypass valve 116, the feed material control chute 13 and the feed material discharge chute 15.

While we have described in the detailed description two configurations that may be encompassed within the disclosed embodiments of this invention, numerous other alternative configurations, that would now be apparent to one of ordinary skill in the art, may be designed and constructed within the bounds of our invention as set forth in the claims. Moreover, both of the above-described novel wireless temperature sensing and control system for metal kiln 10 of the present invention can be arranged in a number of other and related varieties of configurations without expanding beyond the scope of our invention as set forth in the claims.

For example, the system 10 is not necessarily required to be installed in a mass flow delacquering system X as depicted in FIG. 1, but may be installed or otherwise incorporated into a variety of configurations of metal recycling furnace and kiln systems. Further, the system 10 is not constrained to the use of four wireless thermocouples such as 14, 16, 18 and 20. Rather, the system 10 may comprise any number of wireless thermocouples (or other temperature sensing devices), from as few as a single wireless thermocouple up to numerous more than four wireless thermocouples. Likewise, the system 10 is not restricted to a single receiver 22 or a single control unit 24. Depending on the configuration of the recycle system and rotary kiln application, the system 10 may require or it may be desirable to utilize two or more receivers, such as the receiver 22, or two or more control units, such as the control unit 24. In addition, the system 10 is not restricted to using thermocouples, but may utilize any form of temperature sensing device that can be adapted for use in the furnace or kiln environment for which the system 10 is designed.

By way of further example, depending on the configuration of the melt system, it may be necessary or otherwise desirable to include in the system 10 one or more mass flow controllers or other such heat flow control devices in the recycle system X that are capable of adjusting the heat flow in the kiln 12. These other heat flow control devices may be positioned at various locations in the recycle system. Such heat flow control devices may include, for example, a cooling injection port, controllers for various gas supply lines to one or more burners in the melt system, and mechanical in-line dampers for gas flow. It would be recognized by one of ordinary skill in the art that any mechanism that can be manipulated to control the heat flow in the kiln 12 may potentially be incorporated into the system 10. Each of these heat flow control devices can be operatively connected to the control unit 24 such that the control unit 24 regulates the heat flow control devices in response to the temperature readings transmitted to the control unit 24 from the thermocouples 14, 16, 18 and 20. Further, the control unit 24 can be programmed to regulate the heat flow control devices in varying patterns depending on the profile of the temperature readings across the thermocouples 14, 16, 18 and 20, and the durations of those temperature readings at or about any one or more predetermined temperature setpoints.

Additional variations or modifications to the configuration of the novel wireless temperature sensing and control system for metal kiln 10 of the present invention may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of our invention.

What is claimed is:

1. A rotary aluminum kiln temperature regulation system comprising:
a. a temperature sensing device in the rotary aluminum kiln, configured to take temperature readings in an area of the kiln in proximity to the temperature sensing device;
b. a wireless transmitter operatively associated with the temperature sensing device;
c. a receiver wirelessly associated with the transmitter, the transmitter and receiver configured to wirelessly transmit the temperature readings taken by the temperature sensing device from the transmitter to the receiver; and
d. a control unit operatively connected to the receiver, the control unit configured to receive the temperature readings transmitted to the receiver from the temperature sensing device, the control unit further configured to determine when the transmitted temperature readings exceed a predefined temperature setpoint.

2. The system of claim 1, wherein the predefined setpoint is a temperature in excess of the melting temperature of aluminum.

3. The system of claim 1, wherein the control unit is configured to generate a notification when a temperature reading in the kiln exceeds the predefined temperature setpoint.

4. The system of claim 3, wherein the control unit is configured to activate a notification apparatus when the control unit generates the notification.

5. The system of claim 4, wherein the notification apparatus comprises an alarm.

6. The system of claim 1, wherein the control unit is configured to generate a notification when a temperature reading in the kiln exceeds the predefined temperature setpoint for a predetermined duration.

7. The system of claim 1, wherein the temperature sensing device is a thermocouple.

8. The system of claim 1, wherein the control unit is operatively connected to a heat flow control device configured to adjust heat flow inside the kiln in proximity to the temperature sensing device, whereby the control unit regulates the heat flow control device to maintain a desired level of heat flow in the kiln in proximity to the temperature sensing device in response to the temperature readings transmitted from the temperature sensing device.

9. The system of claim 8, wherein the control unit is programmable such that the control unit can automatically regulate the heat flow control device to adjust the heat flow in the kiln at specific times and for specific durations in accordance with a predetermined program.

10. The system of claim 8, wherein the heat flow control device comprises a controllable flow blower.

11. The system of claim 9, wherein the control unit adjusts the blower flow rate in response to the temperature readings transmitted from the temperature sensing device.

12. The system of claim 8, wherein the heat flow control device is selected from the group consisting of:
a pressure control damper;
a combustion blower;
a combustion oxygen supply mass flow controller;
a combustion gas mass flow controller;
a combustion air mass flow controller;
a diverter valve positioned to control the ratio of recirculated heated air from the kiln directed to the afterburner and the kiln;
an emergency vent;
a bypass valve positioned to control the flow of heated gases diverted from the afterburner away from the kiln;
a feed material control chute that regulates the rate at which feed material is supplied to the kiln; and
a feed material discharge chute that regulates the rate at which feed material is discharged from the kiln;
and combinations thereof.

13. The system of claim 1, wherein the control unit is programmable.

14. In combination with a rotary aluminum kiln, a temperature regulation system comprising:
a. At least one temperature sensing device positioned in the kiln, the at least one temperature sensing device configured to take temperature readings in an area of the kiln in proximity to the device;
b. At least one wireless transmitter operatively associated with the at least one temperature sensing device;
c. a receiver positioned outside the kiln and wirelessly associated with the at least one transmitter, the transmitter and receiver configured to wirelessly transmit the temperature readings taken by the sensing device from the transmitter to the receiver;
d. a control unit operatively connected to the receiver, the control unit configured to receive the kiln temperature readings transmitted to the receiver from the at least one temperature sensing device; and
e. a heat flow control device operatively connected to the control unit and configured to adjust the temperature inside the kiln in proximity to the temperature sensing device;
wherein the control unit regulates the heat flow control device to maintain a desired heat flow in the area of the kiln in proximity to the device in response to the temperature readings transmitted from the temperature sensing device.

15. The system of claim 14, wherein the control unit is configured to generate a notification (see above) when the temperature in the area of the kiln in proximity to the device exceeds a predefined temperature setpoint.

16. The system of claim 14 further comprising a plurality of temperature sensing devices.

17. The system of claim 15, wherein the control unit is configured to activate a notification apparatus when the control unit generates the notification.

18. The combination of claim 14, wherein the control unit is configured to detect when a transmitted temperature reading exceed a predefined temperature setpoint for a predetermined duration.

19. The combination of claim 14, wherein the apparatus comprises a controllable flow blower and the control unit adjusts the blower flow rate in response to the temperature readings transmitted from the temperature sensing device.

20. A method of regulating the temperature in a rotary aluminum kiln, the method comprising the steps:
a. ascertaining an upper limit temperature setpoint for a specific operation in the kiln;
b. recording the temperature setpoint in a programmable control unit;
c. operatively connecting the control unit to a notification apparatus;
d. wirelessly connecting the control unit to a wireless temperature sensing and transmitting device;
e. placing the temperature sensing and transmitting device in the kiln, the device configured to take temperature readings in an area of the kiln in proximity to the device and wirelessly transmit the readings to the control unit; and
f. programming the control unit to activate the notification apparatus when the control unit receives a temperature reading from the temperature sensing and transmitting device in the area of the kiln in proximity to the temperature sensing and transmitting device in excess of the temperature setpoint.

21. The method of claim 20, wherein the operation comprises delaquering.

22. The method of claim 20, further comprising the steps of:
a. ascertaining a duration for the kiln to continuously operate at a temperature above the setpoint;
b. recording the duration in the control unit;
c. programming the control unit to activate the notification apparatus when the control unit continuously receives temperature readings from the temperature sensing and transmitting device in the area of the kiln in proximity to the temperature sensing and transmitting device in excess of the temperature setpoint for a period of time that exceeds the recorded duration.

23. The method of claim 20, further comprising the steps:
a. operatively connecting an heat flow control device to the control unit that is configured to adjust the level of heat flow inside the area of the kiln in proximity to the temperature sensing and transmitting device;
b. programming the control unit to regulate the apparatus to maintain a desired temperature in the area of the kiln in proximity to the temperature sensing and transmitting device in response to the temperature readings transmitted from the temperature sensing device.
